(19) United States
(12) Patent Application Publication
(10) Pub. No.: US 2011/0249036 A1
(43) Pub. Date: Oct. 13, 2011

(54) BACKLIGHT UNIT AND DISPLAY APPARATUS HAVING THE SAME

(76) Inventor: Woo-Seok KIM, Seongnam-si (KR)

(21) Appl. No.: 13/071,910

(22) Filed: Mar. 25, 2011

(30) Foreign Application Priority Data
Apr. 12, 2010 (KR) 10-2010-0033500

(51) Int. Cl. G09G 5/10

(52) U.S. Cl. 345/690

(57) ABSTRACT

Provided are a backlight unit and a display apparatus including the same. The display apparatus includes a display panel, a light emitting unit including a plurality of channels, each channel including light emitting diodes configured to irradiate light to the display panel, and a plurality of switches configured to enable current paths of the channels in response to switching signals, and a driver circuit configured to successively enable the switching signals corresponding to the respective channels, compare the duty ratio of the switching signals with 1/channel number, and selectively control the phases of the switching signals based on the comparison result.

### CROSS-REFERENCE TO RELATED APPLICATION

This application claims priority under 35 U.S.C. §119 to Korean Patent Application No. 10-2010-0033500 filed on Apr. 12, 2010, the disclosure of which is hereby incorporated by reference in its entirety.

### BACKGROUND

1. Field

Embodiments of the inventive concept relate to a backlight unit (BLU) and a display apparatus having the same and, more particularly, to a BLU configured to increase the operating efficiency of a converter and a display apparatus having the same.

2. Description of the Related Art

In recent years, with the development of various portable electronic devices, e.g., mobile communication devices and notebook computers, the demand for thin, lightweight display apparatuses applicable to the portable electronic devices has gradually increased. Thus, various display apparatuses, e.g., plasma display panels (PDPs) and liquid crystal displays (LCDs), are being developed and propagated. Among these, the LCDs require BLUs. Although cold cathode fluorescent lamps (CCFLs) have conventionally been used as BLUs, the CCFLs are being gradually superseded by light emitting diodes (LEDs). The LEDs have become strongly relied upon because the LEDs may adopt stable, highly efficient direct-current (DC) power sources, generate small amounts of heat, consume low power, and exhibit environmental friendliness.

In general, a plurality of LEDs may be mounted on a panel of a LCD adopting the LEDs as backlights. The LEDs may be divided into a plurality of channels and driven with a constant current. Both terminals of each of the channels may be maintained at a constant current by a DC-DC converter, and the luminance of each of the channels may be controlled using a pulse width modulation (PWM) method.

However, when all the channels are turned on, load fluctuation may simultaneously occur in all the channels, so that big ripples may occur in an output voltage of the DC-DC converter. The ripples may be increased with an increase in the number of LEDs mounted on the panel. As a result, display apparatuses having the LEDs may suffer from audible noise and wave noise.

### SUMMARY

Embodiments are therefore directed to a BLU and a display apparatus including the same, which substantially overcome one or more of the problems due to the limitations and disadvantages of the related art.

It is therefore a feature of an embodiment to provide a BLU and a display apparatus having a structure capable of equally distributing the fluctuation of load applied to a converter supplying current to a plurality of channels, each of which includes LEDs, and increasing the operating efficiency of the converter.

At least one of the above and other features and advantages may be realized by providing a BLU, including a light emitting unit including a plurality of channels, each channel including light emitting diodes configured to irradiate light, and a plurality of switches configured to activate the channels in response to switching signals; and a driver circuit configured to successively enable the switching signals corresponding to the respective channels, compare the duty ratio of the switching signals with 1/channel number, and selectively control the phases of the switching signals based on the comparison result.

When the duty ratio of the switching signals is greater than 1/channel number, the driver circuit may be configured to shift the phases of the switching signals to successively enable the switching signals at regular intervals within each frame. The driver circuit may be configured to set a phase difference between the switching signals as the 1/channel number.

When the duty ratio of the switching signals is smaller than the 1/channel number, the driver circuit may be configured to successively enable each switching signal at a time point when a previous switching signal is disabled. A starting time of a switching signal may overlap with an ending time of a previous switching signal. The driver circuit may be configured to enable the switching signals without a lapse time therebetween within a frame.

The driver circuit may include a converter configured to apply a constant voltage to the light emitting unit and to supply current to the activated channels, and a switching controller configured to successively enable the switching signals by shifting the phases of the switching signals to be successively enabled at regular intervals within each frame when the duty ratio of the switching signals is greater than the 1/channel number, and to successively enable each of the switching signals at a time point when the previous switching signal is disabled when the duty ratio of the switching signals is smaller than the 1/channel number. The switching controller may include a pulse generator configured to generate pulses having a constant duty ratio to control the luminance of the light emitting unit, a duty-ratio comparator configured to compare the duty ratio of the pulses with the 1/channel number and to output a comparison signal having a different voltage level based on the comparison result, and a phase shifter configured to differently shift the phases of the pulses in response to the comparison signal and to generate the successively enabled switching signals. The phase shifter may include a first phase shifter configured to successively enable the switching signals when the duty ratio of the pulses is smaller than the 1/channel number, and a second phase shifter configured to shift the phases of the pulses and to output the switching signals, which are successively enabled at regular intervals within each frame, when the duty ratio of the pulses is greater than the 1/channel number. The converter may be configured to have a substantially continuous and uniform load, when the duty ratio of the switching signals is smaller than the 1/channel number. The converter may be configured to have substantially constant fluctuations, when the duty ratio of the switching signals is higher than the 1/channel number.

At least one of the above and other features and advantages may also be realized by providing a display apparatus, including a display panel, a light emitting unit including a plurality of channels, each channel including light emitting diodes configured to irradiate light to the display panel, and a plurality of switches configured to activate current paths of the channels in response to switching signal, and a driver circuit configured to successively enable the switching signals corresponding to the respective channels, compare the duty ratio of the switching signals with 1/channel number, and selectively control the phases of the switching signals based on the comparison result.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of a BLU according to embodiments of the inventive concept;

FIG. 2 illustrates a block diagram of a switching controller of FIG. 1;

FIG. 3 illustrates a waveform diagram of operations of a first phase shifter when a duty ratio of a switching signal is lower than 1/channel number;

FIG. 4 illustrates a waveform diagram of operations of a second phase shifter when a duty ratio of a switching signal is greater than 1/channel number; and

FIG. 5 illustrates a block diagram of a display apparatus including a BLU according to embodiments of the inventive concept.

### DETAILED DESCRIPTION

Various embodiments will now be described more fully hereinafter with reference to the accompanying drawings in which some embodiments are shown. These inventive concepts may, however, be embodied in different forms and should not be construed as limited to the embodiments set forth herein. Rather, these embodiments are provided so that this disclosure is thorough and complete and fully conveys the inventive concept to those skilled in the art. In the drawings, the sizes and relative sizes of layers and regions may be exaggerated for clarity.

It will be understood that when an element or layer is referred to as being “on,” “connected to,” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

The terminology used herein is for the purpose of describing particular embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a BLU and a display apparatus including the same according to embodiments of the inventive concept will be described with the appended drawings.

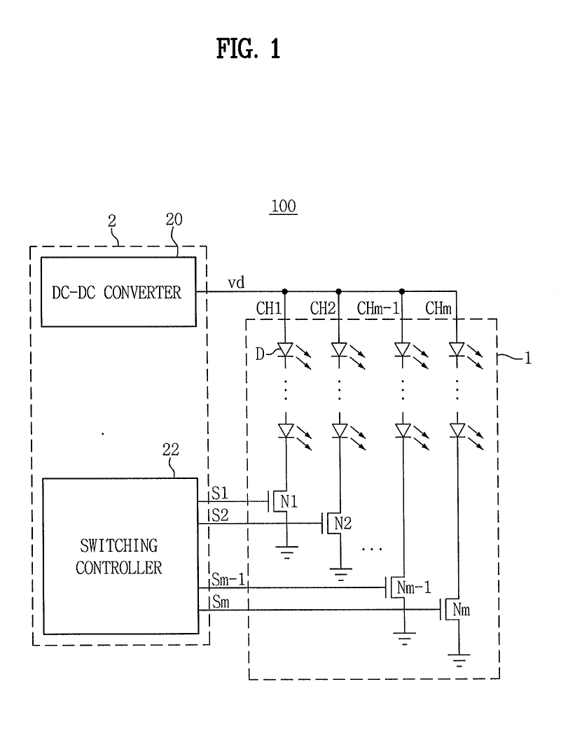

FIG. 1 illustrates a block diagram of a BLU according to embodiments of the inventive concept. Referring to FIG. 1, a BLU 100 according to embodiments of the inventive concept may include a light emitting unit 1 and a driver circuit 2. The driver circuit 2 may include a DC-DC converter 20 and a switching controller 22. Functions of respective blocks of the BLU 100 will now be described.

As illustrated in FIG. 1, the light emitting unit 1 may include a plurality of light emitting diodes (LEDs) D and a plurality of NMOS transistors N1 to Nm. The plurality of LEDs D, which are connected between the DC-DC converter 20 and a ground terminal, may receive current from the DC-DC converter 20 and irradiate, i.e., emit, light. The plurality of NMOS transistors N1 to Nm, which are connected between the LEDs D and the ground terminal, may receive switching signals S1 to Sm from the switching controller 22 and control the emission of the LEDs D in response to the switching signals S1 to Sm. In this case, the light emitting unit 1 may include a plurality of channels CH1 to CHm, each of which includes the LEDs D, and the NMOS transistors N1 to Nm may activate current paths of the channels CH1 to CHm, respectively. That is, each of the channels CH1 to CHm refers to a LED string including the LEDs D.

The DC-DC converter 20, which is a circuit configured to generate a driving voltage Vd maintained at a constant voltage level due to charge pumping, may apply a positive voltage to both terminals of the channels of the light emitting unit 1.

The switching controller 22 may output switching signals S1 to Sm to control the luminance of the light emitting unit 1. Specifically, when the NMOS transistors N1 to Nm are turned on in response to the switching signals S1 to Sm, the current paths of the channels CH1 to CHm may be activated so that current can be supplied from the DC-DC converter 20 to the LEDs D to allow the LEDs D to emit light. In this case, since the amounts of current supplied to the channels CH1 to CHm depend on turn-on periods of the NMOS transistors N1 to Nm, the luminance of light emitted by the LEDs D may also be changed. The switching controller 22 may control a duty ratio per frame of each of the switching signals S1 to Sm to control the luminance of the light emitting unit 1. Here, a frame refers to a cycle of each of the switching signals S1 to Sm corresponding to the channels CH1 to CHm.

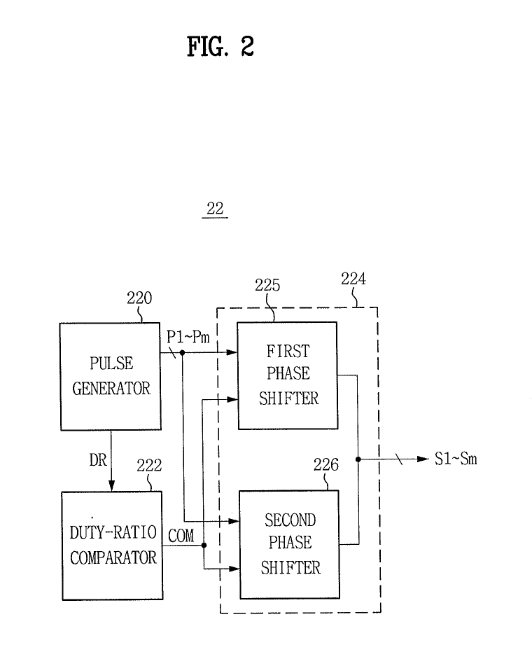

FIG. 2 illustrates a block diagram of the switching controller 22 of FIG. 1. Referring to FIG. 2, the switching controller 22 may include a pulse generator 220, a duty ratio comparator 222, and a phase shifter 224. Functions of respective blocks of the switching controller 22 will now be described.

The pulse generator 220 may generate pulses P1 to Pm having a constant duty ratio to control the luminance of the light emitting unit 1.

The duty ratio comparator 222 may receive duty-ratio information DR from the pulse generator 220, may compare the duty-ratio information DR, i.e., duty ratio of the pulses P1 to Pm generated by the pulse generator 220, with 1/channel number, and may output a corresponding comparison signal COM. That is, the duty-ratio comparator 222 may output a high-level comparison signal COM when the duty ratio of the pulses P1 to Pm is greater than 1/channel number, and may output a low-level comparison signal COM when the duty ratio of the pulses P1 to Pm is lower than 1/channel number. Here, ‘1’ refers a duty ratio of 100%.

When the duty ratio of the pulses P1 to Pm is lower than 1/channel number, the duty ratio of the pulses P1 to Pm may be lower than a period allocated equally to the respective channels for one frame. In other words, the pulses P1 to Pm may be successively output within one frame without superposition periods between the pulses P1 to Pm. Conversely, when the duty ratio of the pulses P1 to Pm is greater than 1/channel number, the duty ratio of the pulses P1 to Pm may be greater than the period allocated equally to the respective channels for one frame. In other words, when the pulses P1 to Pm are generated within one frame, superposition periods may be always generated between the pulses P1 to Pm.

The phase shifter 224 may differently shift the phases of the pulses P1 to Pm according to a voltage level of the comparison signal COM and may generate the switching signals S1 to Sm. The phase shifter 224 may include a first phase shifter 225 and a second phase shifter 226. The first phase shifter 225 may shift the phases of the pulses P1 to Pm and generate the switching signals S1 to Sm when the comparison signal COM is at a low level. The second phase shifter 226 may shift the phases of the pulses P1 to Pm and generate the switching signals S1 to Sm when the comparison signal COM is at a high level. That is, the first and second phase shifters 225 and 226 may be selectively operated based on the comparison result between the duty ratio of the pulses P1 to Pm and 1/channel number, i.e., whether the comparison signal COM is at a low level or at a high level.

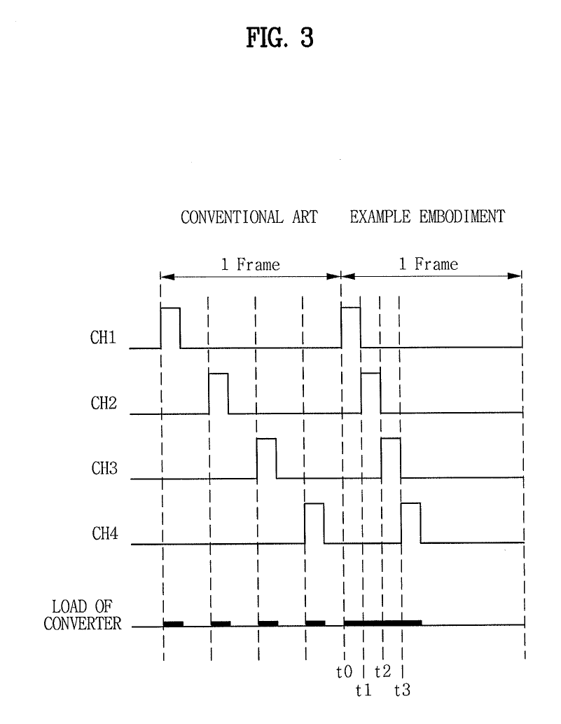

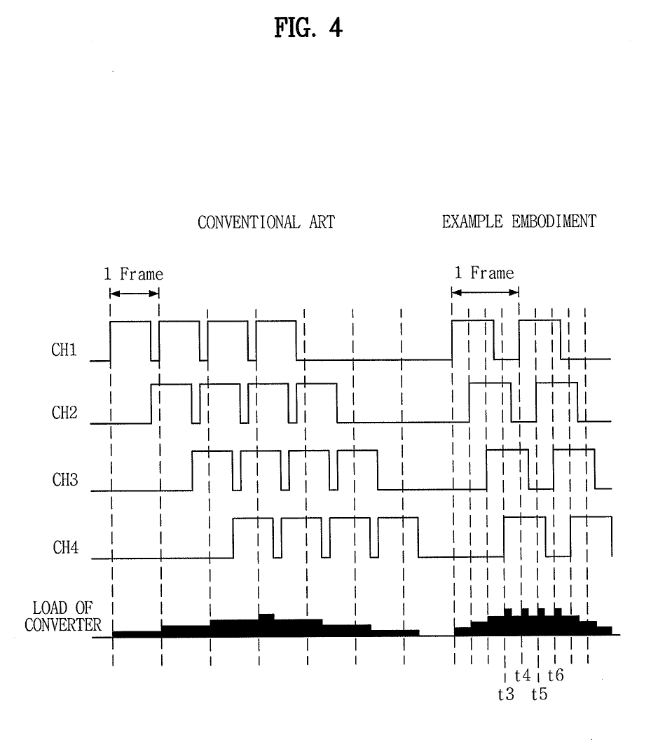

Operations of the BLU 100 will now be described in further detail with reference to FIGS. 1 through 4. FIG. 3 illustrates a signal waveform diagram of the first phase shifter 225 when the duty ratio of a switching signal is lower than 1/channel number, and FIG. 4 illustrates a signal waveform diagram of the second phase shifter 226 when the duty ratio of the switching signal is higher than 1/channel number. Meanwhile, since the switching signals S1 to Sm and the pulses P1 to Pm have different phases and the same duty ratio, the switching signals S1 to Sm will be used interchangeably together with the pulses P1 to Pm.

To begin with, a case where the duty ratio of the switching signals S1 to Sm is lower than 1/channel number will now be described with reference to FIG. 3.

Conventionally, switching signals may be output at time points allocated to corresponding channels for one frame. In this case, since the respective channels operate for different periods, the amount of load applied to the conventional DC-DC converter may be distributed by the channels. Further, since there is a constant time interval between enabling periods of the switching signals, the conventional DC-DC converter may repeat a switching mode, i.e., when current is supplied to an activated channel by a switch of a light emitting unit, and a stop mode, i.e., when supply of current to a disabled channel is interrupted by as much as the number of channels. However, since the conventional DC-DC converter is maintained at a constant voltage by charge pumping, as a time interval at which the switching mode and the stop mode are repeated decreases with an increase in the number of the channels, the response speed of the DC-DC converter may be reduced. Thus, the DC-DC converter may operate irregularly. Also, when a high-level period (i.e., enabling period) of the switching signals is excessively small, even if the switch is instantaneously turned on, the DC-DC converter may not react, and LEDs of a corresponding channel may not properly emit light.

Therefore, the above-described problems may be solved by shifting the phases of the switching signals S1 to Sm using the first phase shifter 225 according to example embodiments. That is, when the duty ratio of the pulses P1 to Pm is less than 1/channel number, the duty-ratio comparator 222 may output a low-level comparison signal COM. The first phase shifter 225 may shift the phases of the pulses P1 to Pm in response to the comparison signal COM, so that the enabling periods of the switching signals S1 to Sm may be continuously connected without periods for which the switching signals S1 to Sm are disabled at the same time.

For example, the first phase shifter 225 may enable a switching signal corresponding to the second channel CH2 at a time point, e.g., time point t₁, when the switching signal corresponding to the first channel CH1 is disabled, and a switching signal corresponding to the third channel CH3 may be activated at a time point, e.g., time point t₂, when the switching signal corresponding to the second channel CH2 is disabled. That is, the first phase shifter 225 may successively enable all the switching signals S1 to Sm by enabling each switching signal at a time point when a previous switching signal is disabled, e.g., without a time lapse between the successive switching signals S1 to Sm.

Since each of the channels CH1 to CHm of the light emitting unit 1 is activated at a time point when the previous channel is disabled, enabling periods of all the channels CH1 to CHm may be connected within one frame. Thus, the DC-DC converter 20 may activate only one switching mode and one stop mode per frame, thereby improving operating efficiency, e.g., the load of the converter may be continuous and uniform within the frame between times t₀ and t₃ as illustrated in FIG. 3 (right side of the graph). Also, since the enabling periods of all the channels CH1 to CHm are connected, even if each of the switching signals S1 to Sm is enabled for a very small period, the DC-DC converter 20 may be prevented from stopping operation.

Next, a case where the duty ratio of the switching signals S1 to Sm is greater than 1/channel number will now be described with reference to FIG. 4.

Conventionally, when a successive phase control method is adopted to connect enabling periods of switching signals, load applied to the conventional DC-DC converter may be successively increased or reduced. In this case, current supplied to the respective channels may be non-uniform according to the response speed of the DC-DC converter, e.g., the load of the converter may be non-uniform as illustrated in FIG. 4 (left side of the graph). Also, in the conventional successive phase control method, as the duty ratio of the switching signals increases, it may take a longer amount of time to enable all the switching signals corresponding to the respective channels. Thus, when the duty ratio of the switching signals, i.e., switching signals that are enabled before the enabling periods of the switching signals are finished, is abruptly changed, the respective channels may temporarily have non-uniform luminance.

According to the inventive concept, however, the above-described problems may be solved by shifting the phases of the switching signals S1 to Sm using the second phase shifter 226.

That is, when the duty ratio of the switching signals S1 to Sm is greater than 1/channel number, superposition between the switching signals S1 to Sm may be unavoidable in successively enabling all the switching signals S1 to Sm within each frame. Thus, when the duty ratio of the switching signals S1 to Sm is greater than 1/channel number, superposition periods between the switching signals S1 to Sm may be uniformly adjusted so that the fluctuation of load applied to the DC-DC converter 20 can be distributed equally.

In other words, when the duty ratio of the pulses P1 to Pm is greater than 1/channel number, the duty-ratio comparator 222 may output a high-level comparison signal COM. The second phase shifter 226 may shift the phases of the pulses P1 to Pm and may generate switching signals S1 to Sm to be successively enabled at regular intervals within each frame, e.g., the intervals of the enabled switching signals S1 to Sm may be adjusted to provide current to first through fourth channels CH1 through CH4 within a same frame as illustrated in FIG. 4 (right side of the graph). Here, a time interval between time points when the switching signals S1 to Sm are enabled may be set as 1/channel number. In this case, load which fluctuates relatively constantly, e.g., see constant fluctuations in times t₃ through t₆ in FIG. 4, may be applied to the DC-DC converter 20 so that the load fluctuation can be equally distributed.

As described above, the BLU according to the embodiments of the inventive concept may successively control the enabling periods of the channels and equally distribute the fluctuation of load applied to the DC-DC converter 20 supplying current to the channels CH1 to CHm. Also, the BLU may reduce the number of times the DC-DC converter 20 repeats an operation per frame to prevent a malfunction from occurring in the DC-DC converter 20 due to the response speed of the DC-DC converter 20. As a result, the operating efficiency of the DC-DC converter 20 may be increased.

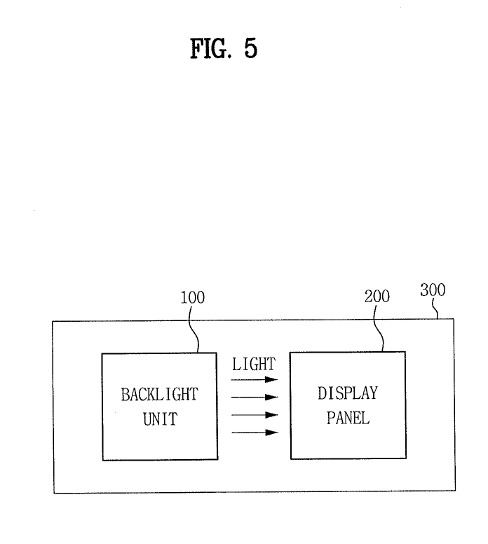

FIG. 5 illustrates a block diagram of a display apparatus including a BLU according to embodiments of the inventive concept. Referring to FIG. 5, a display apparatus 300 may include the BLU 100 and a display panel 200. The BLU 100 may irradiate light to the display panel 200, and the display panel 200 may transmit light to create a desired image.

More specifically, the BLU 100 may include a plurality of channels, each of which includes a plurality of LEDs, and a DC-DC converter configured to supply current to activated channels. The BLU 100 may successively activate the respective channels and control phase differences between enabling periods of the respective channels. Thus, the fluctuation of load applied to the DC-DC converter may be equally distributed and the operating efficiency of the DC-DC converter may be increased.

As described above, a BLU and a display apparatus including the same according to embodiments of the inventive concept may differently control time points when a plurality of channels are activated, so that the fluctuation of load applied to a DC-DC converter can be distributed. Furthermore, the BLU and the display apparatus may reduce the number of times the DC-DC converter repeats an operation per frame to improve the operating efficiency of the DC-DC converter.

The foregoing is illustrative of embodiments and is not to be construed as limiting thereof. Although a few embodiments have been described, those skilled in the art will readily appreciate that many modifications are possible in embodiments without materially departing from the novel teachings and advantages. Accordingly, all such modifications are intended to be included within the scope of this inventive concept as defined in the claims. In the claims, means-plus-function clauses are intended to cover the structures described herein as performing the recited function, and not only structural equivalents but also equivalent structures. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A backlight unit, comprising:
a light emitting unit including:
a plurality of channels, each channel including light emitting diodes configured to emit light, and
a plurality of switches configured to activate the channels in response to switching signals; and
a driver circuit configured to successively enable the switching signals corresponding to respective channels, to compare a duty ratio of the switching signals with 1/channel number, and to selectively control phases of the switching signals based on the comparison result.

2. The backlight unit as claimed in claim 1, wherein, when the duty ratio of the switching signals is greater than 1/channel number, the driver circuit is configured to shift the phases of the switching signals to successively enable the switching signals at regular intervals within each frame.

3. The backlight unit as claimed in claim 2, wherein the driver circuit is configured to set a phase difference between the switching signals as the 1/channel number.

4. The backlight unit as claimed in claim 1, wherein, when the duty ratio of the switching signals is smaller than the 1/channel number, the driver circuit is configured to successively enable each switching signal at a time point when a previous switching signal is disabled.

5. The backlight unit as claimed in claim 4, wherein a starting time of a switching signal overlaps with an ending time of a previous switching signal.

6. The backlight unit as claimed in claim 4, wherein the driver circuit is configured to enable the switching signals without a lapse time therebetween within a frame.

7. The backlight unit as claimed in claim 1, wherein the driver circuit comprises:
a converter configured to apply a constant voltage to the light emitting unit and to supply current to the activated channels; and
a switching controller configured to successively enable the switching signals by shifting the phases of the switching signals to be successively enabled at regular intervals within each frame when the duty ratio of the switching signals is greater than the 1/channel number, and to successively enable each of the switching signals at a time point when the previous switching signal is disabled when the duty ratio of the switching signals is smaller than the 1/channel number.

8. The backlight unit as claimed in claim 7, wherein the switching controller comprises:
a pulse generator configured to generate pulses having a constant duty ratio to control the luminance of the light emitting unit;
a duty-ratio comparator configured to compare the duty ratio of the pulses with the 1/channel number and to output a comparison signal having a different voltage level based on the comparison result; and
a phase shifter configured to differently shift the phases of the pulses in response to the comparison signal and to generate the successively enabled switching signals.

9. The backlight unit as claimed in claim 8, wherein the phase shifter comprises:
a first phase shifter configured to successively enable the switching signals when the duty ratio of the pulses is smaller than the 1/channel number; and
a second phase shifter configured to shift the phases of the pulses and to output the switching signals, which are successively enabled at regular intervals within each frame, when the duty ratio of the pulses is greater than the 1/channel number.

10. The backlight unit as claimed in claim 7, wherein the converter is configured to have a substantially continuous and uniform load, when the duty ratio of the switching signals is smaller than the 1/channel number.

11. The backlight unit as claimed in claim 7, wherein the converter is configured to have substantially constant fluctuations, when the duty ratio of the switching signals is higher than the 1/channel number.

12. A display apparatus, comprising:
a display panel;
a light emitting unit including a plurality of channels, each channel including light emitting diodes configured to emit light to the display panel, and a plurality of switches configured to activate current paths of the channels in response to switching signals; and
a driver circuit configured to successively enable the switching signals corresponding to the respective channels, to compare the duty ratio of the switching signals with 1/channel number, and to selectively control phases of the switching signals based on the comparison result.

13. The display apparatus as claimed in claim 12, wherein, when the duty ratio of the switching signals is greater than 1/channel number, the driver circuit is configured to shift the phases of the switching signals to successively enable the switching signals at regular intervals within each frame.

14. The display apparatus as claimed in claim 13, wherein the driver circuit is configured to set a phase difference between the switching signals as the 1/channel number.

15. The display apparatus as claimed in claim 12, wherein, when the duty ratio of the switching signals is smaller than the 1/channel number, the driver circuit is configured to successively enable the switching signals.

16. The display apparatus as claimed in claim 12, wherein the driver circuit comprises:
a converter configured to apply a constant voltage to the light emitting unit and supply current to the activated channel; and
a switching controller configured to successively enable the switching signals by shifting the phases of the switching signals to be successively enabled at regular intervals within each frame when the duty ratio of the switching signals is greater than the 1/channel number and enabling each of the switching signals at a time point when the previous switching signal is disabled when the duty ratio of the switching signals is smaller than the 1/channel number.

17. The display apparatus as claimed in claim 16, wherein the switching controller comprises:
a pulse generator configured to generate pulses having a constant duty ratio to control the luminance of the light emitting unit;
a duty-ratio comparator configured to compare the duty ratio of the pulses with the 1/channel number and output a comparison signal having a different voltage level based on the comparison result; and
a phase shifter configured to differently shift the phases of the pulses in response to the comparison signal and generate the successively enabled switching signals.

18. The display apparatus as claimed in claim 17, wherein the phase shifter comprises:
a first phase shifter configured to successively enable the switching signals when the duty ratio of the pulses is smaller than the 1/channel number; and
a second phase shifter configured to shift the phases of the pulses and output the switching signals, which are successively enabled at regular intervals within each frame, when the duty ratio of the pulses is greater than the 1/channel number.

19. A display apparatus, comprising:
a display panel; and
a backlight unit including a light emitting unit and a driver circuit, the light emitting unit having a plurality of channels, each channel including light emitting diodes configured to emit light to the display panel, and a plurality of switches configured to activate current paths of the channels in response to switching signals, and the driver circuit being configured to successively enable the switching signals corresponding to the respective channels, to compares the duty ratio of the switching signals with 1/channel number, and to selectively controls the phases of the switching signals based on the comparison result.

20. The display apparatus as claimed in claim 19, wherein the backlight unit further comprises a converter configured to supply current to the activated channel.
